(19) United States
(12) Patent Application Publication
(10) Pub. No.: US 2005/0095093 A1
(43) Pub. Date: May 5, 2005

(54) Storage retrieval system comprising a load receiving element

(76) Inventor: Rudolf Hansl, Altmunster (AT)

Correspondence Address: WILLIAM COLLARD;COLLARD & ROE, P.C., 1077 NORTHERN BOULEVARD, ROSLYN, NY, 11576, US

(21) Appl. No.: 10/505,759

(22) PCT Filed: Feb. 18, 2003
(86) PCT No.: PCT/AT03/00052

(30) Foreign Application Priority Data
Feb. 25, 2002 (AT) GM 121/2002

(51) Int. Cl. B65G 1/00; B65G 65/00

(52) U.S. Cl. 414/277; 414/281

(57) ABSTRACT

The invention relates to a shelf-serving device (1) for stocking and removing from storage pallets (6), storage boxes etc. in a shelf stockroom (2), comprising a lifting carriage (17) displaceable in a shelf lane (7) in the longitudinal and up directions, and a telescopic, extendable and retractable load-receiving means (20) adapted to drive into shelves (3) of the shelf stockroom. At least one load-carrying means (25) and one load-supporting means (24) supporting the end extension (21) in the course of adjustment vis-à-vis the shelf, are adjustably arranged between a position on the lifting carriage (17) and a position in the shelf (3).

The invention relates to a shelf-serving device as defined in the introductory part of claim 1.

A method and a device for manipulating shipping pallets are known from DE 44 22 240 A1. The device is comprised of a transfer system with a lifting platform and telescopic arms arranged thereon, for loading shipping pallets on support rails in a storage shelf or removing them from the latter. Furthermore, for manipulating the shipping pallets, an endless conveyor is arranged between the telescopic arms and can be displaced from the lifting platform with the telescopic arms. Such an arrangement has the drawback that high load moments occur due to the wide swing required when the shipping pallets are loaded on or removed from the shelf, and the high dead weight conditioned by the device.

Furthermore, a method and a device for loading and removing containers in/from a shelf compartment, with an extendable system with revolving conveying means, are known from DE 198 01 856 C2. In this system, the conveying means is forming a support surface and, for rolling off on the bottom side of the container, driven against the loading or unloading directions in which the extendable component is moving so as to avoid any relative movement. A high dead weight, which has to be absorbed by the shelf-serving device, is reached in such a system as well, and the extra load added by the container causes high moments in the conveying system in the extended condition. This requires the systems to be dimensioned accordingly, which incurs high costs and also leads to high energy consumption for operating such system installations.

According to another type of device of the type known from DE 34 31 580 A1, a conveyor device for all kinds of different commodities with or without pallets is comprised of parallel-extending support and guide sections, in which a transporting and displacing platform is displaceably guided by means of castors. Such a transporting and displacing platform comprises a plurality of supporting and displacing means preferably in the form of rollers, on which the goods or pallets are supported and received or shipped. Such a system is basically installed on the shelves as such, so that the containers or pallets can be stocked on or removed from the shelf by a conveying means.

The problem of the invention is to provide a shelf-serving system of a lighter weight and consequently more economical type of construction, with which a wide swing for stocking and removing the usual shipping units in single- or double-shelf arrangements is achieved, and the material expenditure for the device is minimized.

The problem of the invention is resolved by the features specified in the characterizing part of claim 1. The advantage gained in this connection is that by additionally arranging a load-supporting means on the load-carrying means, support of the telescopic assembly is obtained on the shelf without any substantial additional stress being exerted on the shelf. In this way, no load moments have to be absorbed by the supporting structure of the shelf-serving device, which means that significant savings are gained in connection with the dimensioning of the shelf-serving system, and, by virtue of reduced stress, a longer useful life of such devices as well.

However, a design as specified in claims 2 to 4 can be realized as well, as is permits adaptation of the load-receiving means for obtaining high stability irrespectively of the configuration of pallets, storage boxes etc.

Beneficial is also an embodiment as defined in claim 5, by which a low structural height of the load-receiving means is achieved, and thus high utilization of the storage space.

Another advantageous design is specified in claim 6, as an optimized layout of the load-carrying and/or load-supporting means is achieved in this way in the given case of application.

Furthermore, beneficial embodiments as those specified in claims 7 to 9 lead to application possibilities for serving double-shelves in an economical manner where required as well.

However, preferred further developments are specified also in claims 10 and 11, as the drive of the telescopic assembly arranged on the lifting carriage is supported and relieved in this manner as the latter is being driven into the shelf for picking up pallets, storage boxes etc., and any relative movement between the final telescopic extension and the pallets or storage boxes is avoided by adapting its speed.

Beneficial is also an embodiment according to claim 12, as an angular adjustment to the required extent is obtained in this manner for achieving the full support function between the load-supporting means and the shelf construction, and any deformation of the structure of the device is avoided.

According to the beneficial further development as specified in claim 13, the pallet can be pulled from the shelf, or the storage box from its support and shelf, owing to the fact that the frictional resistance on the load-carrying means is greater than the frictional resistance versus the support means.

Feasible is also an embodiment as specified in claim 14, which offers a beneficial variation for its application to storage boxes provided with a through-extending bottom.

An exact transfer of pallets, storage boxes etc. to the load-carrying means in terms of their positioning is achieved with the further development as specified in claim 15.

However, embodiments of the type specified in claims 16 to 18 are advantageous as well, which permit adaptation of the system to various layouts of shelf stockrooms and different types of storage.

Furthermore, the design specified in claim 19 is beneficial because driving into a pallet can be safely accomplished even if positioning tolerances should occur.

According to the advantageous further developments of the invention specified in claims 20 to 25, the caterpillar track assemblies can be driven into a pallet vibration-free, with no tilting movement occurring where it is possible to lift the pallet in its horizontal position after the caterpillar track arrangements have been fully driven into the shelf. Very careful stocking and stock removal from the shelves is achieved in this manner for sensitive goods.

A design according to claim 26 is beneficial because it permits receiving the pallet in a secured manner.

Finally, embodiments as specified in claims 27 and 28 are advantageous as well because in this way, it is possible to take into account in particular different means for receiving merchandise, and thus solutions adapted accordingly are available.

The exemplified embodiments shown in the drawings are explained in greater detail in the following for superior understanding of the invention. In the drawings,

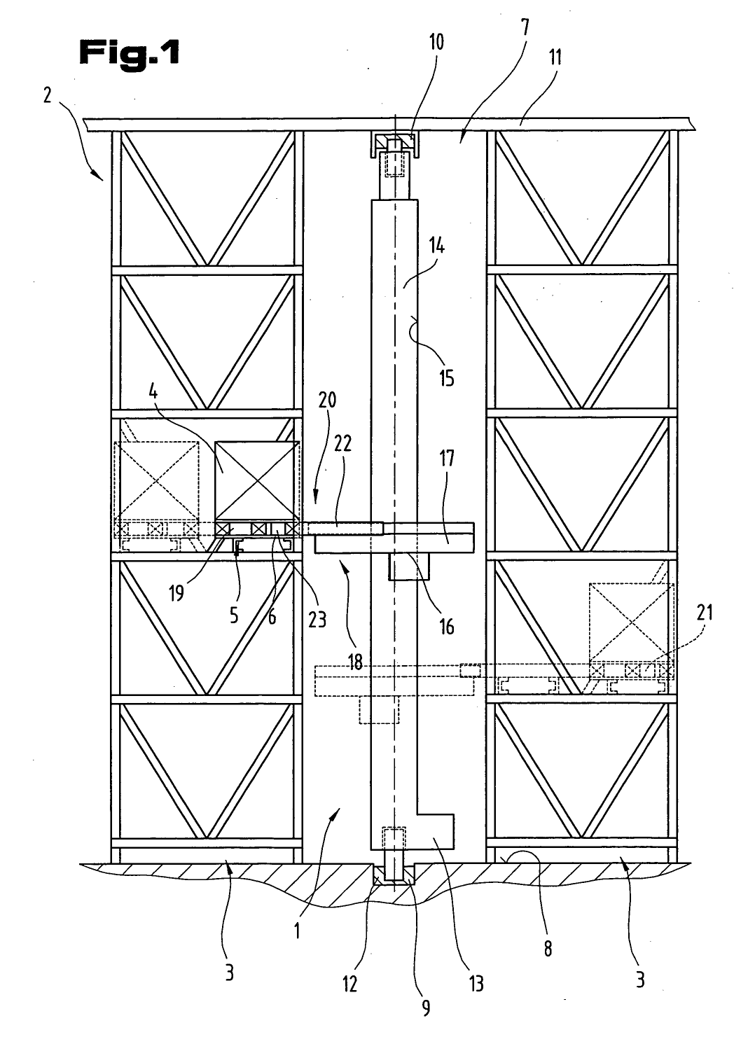

FIG. 1 is a view of a shelf stockroom with a shelf-serving system as defined by the invention.

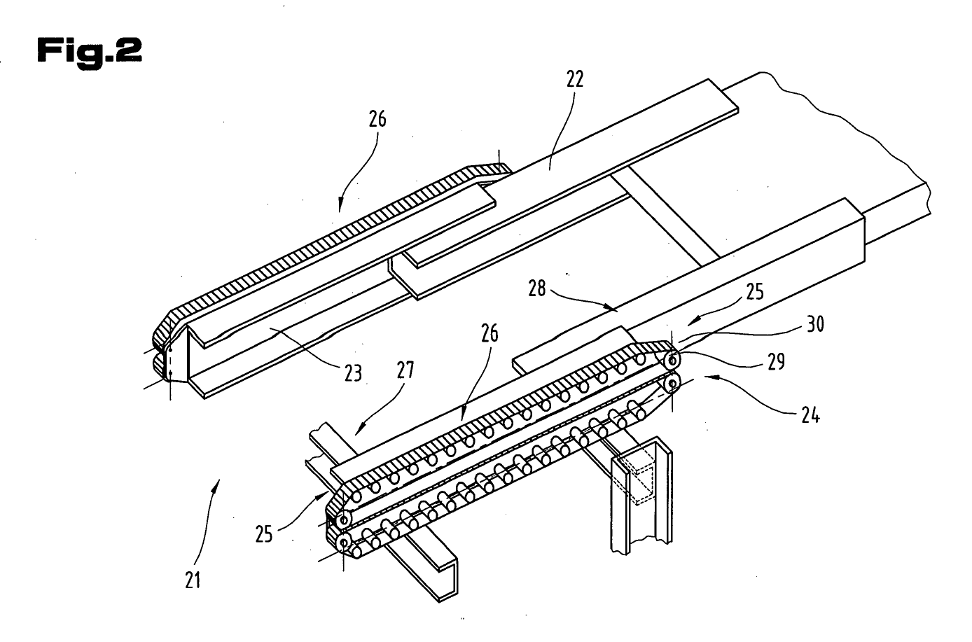

FIG. 2 is a schematic representation of the load-receiving means by an slanted view.

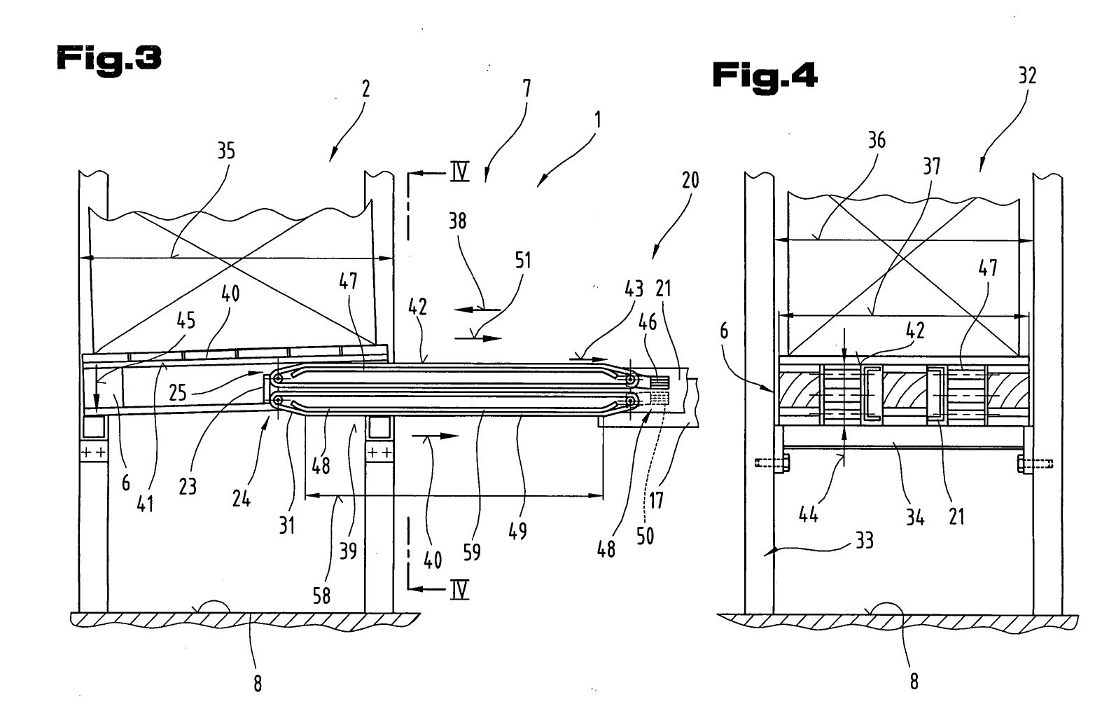

FIG. 3 shows by a partially sectional view the load-receiving means driven partly into the shelf area for picking up a pallet.

FIG. 4 is a sectional view of the load-receiving means sectioned according to lines IV-IV in FIG. 3.

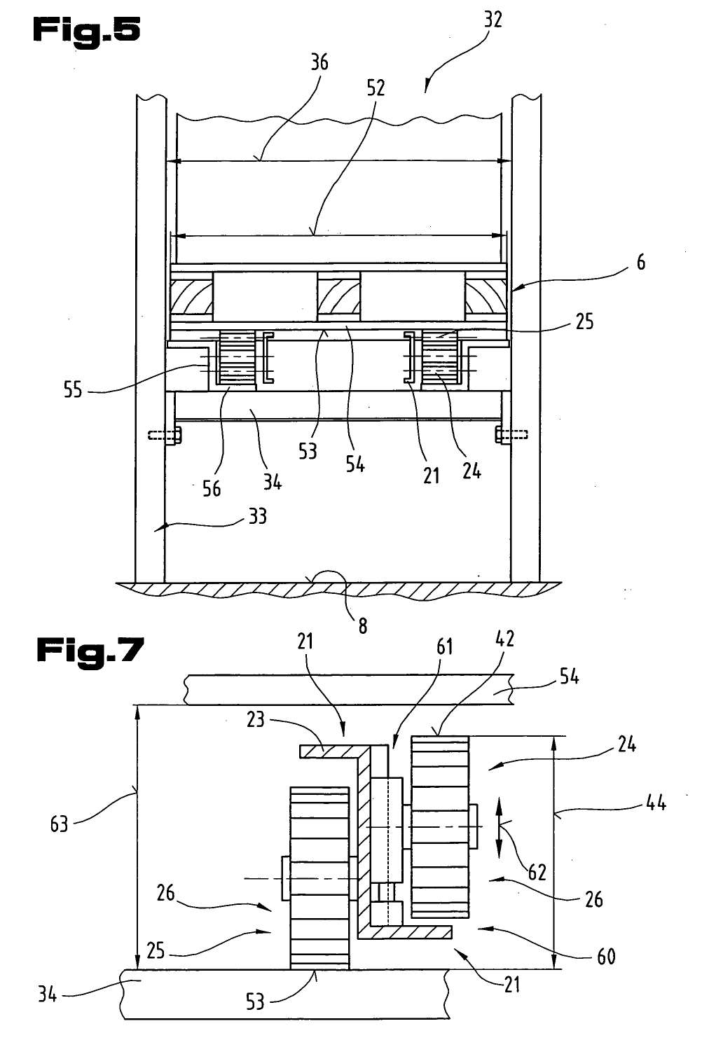

FIG. 5 shows another embodiment of the support of pallets for unloading the latter from the load-receiving means of the shelf-serving system as defined by the invention.

FIG. 6 is another embodiment of the load-receiving means shown by a slanted view.

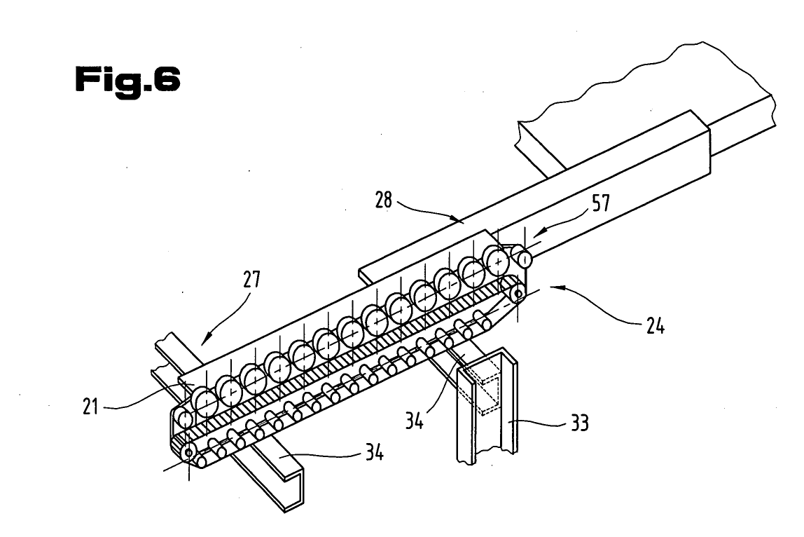

FIG. 7 shows yet another embodiment comprising laterally offset caterpillar track assemblies for the load-receiving means.

It is noted here by way of introduction that in the various forms of embodiment described herein, identical components are provided with identical reference numerals and identical component drawings, whereby the disclosures contained throughout this specification can be applied in the same sense to identical components with identical reference numerals and identical component drawings. Furthermore, the positional data selected in the specification such as, e.g. on top, at the bottom, lateral etc. relate to the figure directly described and shown, and have to be applied in the same sense to the new position where a position has changed. Moreover, individual features or combinations of features in the various exemplified embodiments described and shown herein may also represent independent inventive solutions, or solutions as defined by the invention.

FIG. 1 shows a shelf-serving device 1 and a shelf storage 2 by the example of a high-shelf stockroom equipped with the shelves 3 for warehousing the goods, merchandise 4 on or in the merchandise-receiving means 5, e.g. pallets. In the present case, the shelf-serving device 1 is a mast 14 that is extending, for example in a shelf lane 7 in a rail 9 extending over a set-up surface 8, and in a rail 10 extending on a ceiling 11 of the shelf stockroom 2, with the undercarriages 12 and a driving arrangement 13. Said mast forms a guiding arrangement 15 for a lifting carriage 17 that is adjustable in the vertical direction by means of a drive 16.

According to the prior art, the lifting carriage 17 is provided with a telescopic assembly 18, preferably a doubly extendable telescopic fork arrangement 19 that is adjustable in a plane extending parallel to the set-up surface 8. Starting from the shelf lane 7, the shelves 3 arranged on both sides of the shelf lane 7, which are double-shelves as shown, can be selectively served for loading and unloading the shelves with the merchandise-receiving means 5, namely irrespectively of whether the pallet 6, which is shown by fully drawn lines and disposed adjacent to the shelve lane 7, or a pallet 7 that is removed from the shelve lane 6 and shown by dashed lines, or both pallets have to be jointly loaded on or removed from the shelves. It has to be noted that the shelf storage facility 2 may naturally be realized also in the form of individual shelves not shown, whereby the economically sounder solution is represented by the double-shelf layout shown in the exemplified embodiment. The shelf 3 may be designed both for longitudinal and crosswise storage of the merchandise-receiving means 5, e.g. of the pallets 6 such as Euro-pallets etc. with a rectangular layout. Other layouts of the merchandise-receiving means 5 are, of course, possible as well.

Now, FIG. 2 shows a schematically simplified representation of a load-receiving means 20 of the shelf-serving device 1 realized as defined by the invention in the form of a fork arrangement 19 of the telescopic assembly 18, whereby for the sake of simplification, drive arrangements for the telescopic assembly 18 known from the prior art, as well as detailed representations of guides etc. are not shown, and the telescopic assembly 18 is shown in a simplified manner in the form of U-sections that engage one another and can be adjusted relative to each other via an adjusting device.

In connection with a single- or multiple-component telescopic arrangement 18, it is essential to the invention in connection with the load-receiving means 20 that an end extension 21 of the telescopic arrangement 18 forming the fork arrangement 19, or of the telescopic arms 22, 23 forming the forks, is provided with a load-supporting means 24 and a load-carrying means 25. In a preferred embodiment, said means are formed by the caterpillar track arrangements 26, which substantially are rotationally supported in the end areas 27, 28 of the telescopic arms 22, 23, opposing each other with respect to the set-up surface 8, and aligned with one another one on top of the other, rotating about the parallel axles 29 of the reversing gears 30. Said caterpillar tracks arrangements each have the independent revolving means 31, e.g. chains, belt, cables etc. endlessly guided via the reversing gears 30.

According to a preferred embodiment, the caterpillar track arrangements 26 or revolving means 31, by virtue of the arrangement and diameter of the reversing gears 30 and their coordinated positions, are provided in the end areas with support guides for the revolving means 31 so as to facilitate their drive into the shelf and pick-up of the pallets 6 even in the presence of dimensional and positional deviations.

Furthermore, FIGS. 3 and 4 show a shelf space 32 between the two shelf posts 33 and the support profiles 34 connecting said posts, forming a surface for placing the merchandise-receiving means 5, particularly the pallet 6, in a plane parallel to the set-up surface 8. In the present embodiment, provision is made for storing the pallets 6 with a rectangular layout lengthwise, whereby a depth 35 of the shelf space 32 is dimensioned for lengthwise storage, and an inside width 36 between the shelf posts 33 is just slightly larger than a width 37 of the pallet 6 or the merchandise-receiving means 5.

Now, FIG. 3 in particular shows the load-receiving means 20 of the shelf-serving device 1 after it has been partly driven into the shelf with its end-side telescopic arms 23 in the drive-in direction (indicated by arrow 38), for removing the pallet 6 with the merchandise loaded on the latter. The telescopic arms 23 are spaced from each other in the direction of width 37, and are provided with the caterpillar track arrangements 26, which are disposed one on top of the other and aligned with one another, whereby one caterpillar track assembly 26 per telescopic arm 23 is resting against the support profile 34 and rolling off on the latter (as indicated by arrow 40) with a surface 39, the latter facing the set-up surface 8 and being formed by the endless revolving means 31. This means the dead weight and also the extra weight added by the load are carried by the structure of the shelf. Therefore, as soon as the caterpillar track arrangement 26 of the load-supporting means 24 is resting on the support profile 34 as it is being driven into the shelf space 32, no load moments are acting on the shelf-serving device 1 or the mast 4, the driving carriages 12 etc.

For receiving the pallet 6, the load-carrying means 25, which are formed by another caterpillar track assembly 26, are associated with a pallet bottom 40 per each telescopic arm 22, whereby in the course of driving in (as indicated by arrow 38), the endless revolving means 31 of the load-carrying means 25, by rolling off on an underside 41 of the pallet bottom 40, is moving under the pallet 6 with a surface 42 facing away from the set-up surface 8. A spacing 44 between the surfaces 39, 42 of the endless revolving means 31, said spacing being measured in the vertical direction in relation to the set-up surface 8, is dimensioned in a way such that a supporting force —indicated by arrow 45—acting on the pallet 6 on the support profiles 34 is reduced, or the spacing 44 is made greater than the inside height of the pallet, which causes the pallet 6 to assume a slanted position as it is being driven in as shown in FIG. 3. Depending on the position of the center of gravity of the pallet 6, the latter, following a tilting movement, comes to rest on the load-carrying means 25 horizontally as it is being driven in further, and is then completely lifted from the support profile 34.

In order for the pallet 6 to be reliably received on the load-carrying means 25 as the load-receiving means 25 is being driven in, as indicated by arrow 38, and the support force is reduced as indicated by arrow 45, and the pallet is then lifted from the support profile 34, the caterpillar track arrangement forming said load-carrying means is equipped with a drive 46, by means of which the endless revolving means 31 is driven in the direction against the drive-in direction—indicated by arrow 38—in accordance with the drive-in speed of the end extension 21, with the upper stand 47 rolling off on the pallet bottom 40, so that no relative movement is caused to occur between the load-carrying means 25 and the pallet 6.

According to a preferred embodiment, provision is made also for a drive or driving connection 48—as shown by dashed lines—for the caterpillar track arrangement 26 of the load-supporting means 24, for the purpose of supporting the roll-off movement of a lower strand 49 on the support profile 34 as indicated by the arrow 40.

It is in particular pointed out that instead of employing the separate drives 46, the driving connection 48 between the caterpillar track arrangement 26 can be realized, e.g. in the form of a transmission 50 as well, whereby it is necessary—as explained further below—to provide the driving connection 48 or transmission 50 with a release device so as to be able to disengage the driving connection 48 between the load-supporting means 24 and the load-carrying means 25. Such disengagement is required for the driving-out movement as indicated by arrow 51 after the end extension 21 has been fully driven into the shelf space 32, and thus into the pallet 6, and for then removing the pallet 6 from the shelf 3 after it has been deposited on the caterpillar track arrangement 26 of the load-carrying means 25. In the process of such a movement for removing and driving the pallet out, as indicated by arrow 51, the caterpillar arrangement 26 of the load-carrying means 25 is prevented from carrying out a roll-off movement by means of a blocking device 51 or the drive 26. In this way, the pallet 6 is pulled by the support profiles 34 and the frictional resistance acting between the upper strand 47 and the pallet bottom 40; and by retracting the telescopic arrangement 18 into the zero position vis-à-vis the lifting carriage 17, it is transported into the shelf lane 7, and then transported out of the shelf stockroom 2 by displacing the shelf-serving device 1 accordingly.

According to a preferred embodiment, as the end extension 21 is being retracted from the shelf 3 as indicated by arrow 51, the caterpillar track arrangement 26 of the load-supporting means 24, the latter resting on at least one of the support profiles 34 with the lower strand 49, and thus supporting the telescopic arrangement 18, the caterpillar track arrangement 26 is driven in the direction against the driving-in direction in order to support the driving-out movement and to avoid any relative movement between the lower strand 49 and the supporting profile.

In a simplified embodiment, in particular with lower stocking loads, the drive 46 for the caterpillar track arrangement 26 of the load-supporting means 24, or the arrangement of the driving connection 48 can be omitted, if need be; however, the drive 46 for the caterpillar track arrangement 26 of the load-carrying means 25 is useful and indispensable in any case.

Now, FIG. 5 shows another embodiment for so-called crosswise storage of the pallet 6, in which the width 36 between the shelf posts 33 is slightly larger than a length 52 of the pallet 6. In this connection, and particularly with standard pallets, for driving the load-carrying means 25 or end extension 21 in between the support profile 34 and the pallet 6, it is necessary due to the construction of such pallets 6 to support the latter at a higher level vis-à-vis the support profile 34, because with this type of storage of the pallet 6, provision is made for the reinforcing profiles 54, which extend in the direction of the length 52, forming an underside 53.

According to a preferred embodiment, the pallet 6 is supported in this case in the shelf space 52 on the particularly Z-shaped profiles 55 extending in the direction of the depth 35, whereby the legs 56 of the Z-profiles 55 resting on the support profiles 34 of the shelf 3 are pointing at each other. In this preferred embodiment, a through-extending support is formed by the leg 56 for the caterpillar track arrangement 26 of the load-supporting means 24, and thus serves for supporting the end extension 21 of the load-carrying means 25. Other profiles, however, naturally can be employed as well, i.e. support elements assuring the required elevation only in the region of the support profiles 34, because as described above for the preceding exemplified embodiments, the caterpillar arrangement 26 of the load-supporting means 25 can be supported also on the support profile 34.

It has to be mentioned also that with yet another design variation, it is possible also to make provision for a roller arrangement 57 replacing the caterpillar track arrangement 26 of the load-carrying means 25, specially when merchandise-receiving means 5 with a through-extending bottom cover as shown by a basic representation in FIG. 6 are used, whereby it is possible also in such a case to equip the roller arrangement 57 with the drive 46 and the blocking device 51, and to realize the roller arrangement in a manner such that the drive-in and drive-out inclinations in the end areas described already above in connection with the preceding figures, will be present here in the end areas of the load-carrying means 25 and the load-supporting means as well.

Referring again to FIG. 3, it should be noted also that various possibilities are available for providing the required support of the upper and lower strands 47 and 48, respectively, of the caterpillar arrangements 26 in order to make provision for obtaining support for the revolving means 31 that is acting over a parallel-extending length 58. Such devices are, e.g. the rigidly arranged guiding arrangements 59, which are provided with a low-friction coating, e.g. Teflon or aramide coating, etc. Support rollers, of course, can be employed as well.

FIG. 7 shows another embodiment, according to which provision is made for arranging the caterpillar track arrangements 26 for the load-carrying and load-supporting means 25, 24, respectively, not in an aligned manner, but in laterally offset planes on the telescopic arm 23, which permits the caterpillar track arrangements 26 to overlap, so that the end extension 21 thus may have a low structural height. Furthermore, in such an embodiment, provision can be made for an adjusting device 60 for at least one of the caterpillar track arrangements 26, by which the spacing 44 between the surface 39 and the surface 42 of the upper and lower strands 47 and, respectively, 49, is variable by means of adjustment in a guide arrangement 61, as indicated by a double arrow 62. In this way, when driving into the shelf 3, it is possible to set a spacing 44 that is smaller than an inside height 63 of the substructure of the pallet, i.e., driving into the pallet 6 will not cause the latter to assume a slanted position. After the load-carrying means 25 has been completely driven in, the spacing 44 is increased by actuating the adjusting device 60, to a measure greater than the inside height 61, whereby the load-supporting means 24 comes to rest against the supporting profile 34, and the pallet 6 with the merchandise 4 is lifted from the supporting profile 34 in its horizontal position. The adjusting device 60, of course, is designed for a lifting force conforming to the maximum weight to be expected. Various technical solutions such as eccentric drives, spindle drives, hydraulic cylinders etc. are available for such an adjusting device 60, which do not need to be addressed here in greater detail. Such an embodiment offers particularly for stocked vibration-sensitive goods the advantage that no vibration of the merchandise is caused by any tilting movement. It is also pointed out that such an adjusting device 60 is not limited to the exemplified embodiment shown in FIG. 7, but applicable to the embodiments described in the foregoing as well.

It is, of course, necessary also to mention the controlling and monitoring devices and elements for which provision is made, but which are not specified herein in detail, particularly the ones for the drives 46 such as the speed, rpm- and rpm-reversing controllers; the synchronizer, approximation sensors, and overload protection devices etc., which individually conform to the state of the art and are provided for operational reliability and safety reasons.

For the sake of good order, it is finally emphasized that in the interest of superior appreciation of the structure of the shelf-serving device 1, the latter and its components are partly shown untrue to scale and/or enlarged and/or reduced.

The problems forming the basis of the independent inventive solutions can be derived from the specification.

Most of all, the individual embodiments shown in FIGS. 1; 2, 3, 4; 5, 6; 7 may constitute objects of independent solutions as defined by the invention. The relevant problems and solutions as defined by the invention can be derived from the detailed descriptions of these figures.

### List of Reference Numerals

1 Shelf-serving device
2 Shelf stockroom
3 Shelf
4 Merchandise
5 Merchandise-receiving means
6 Pallet
7 Shelf lane
8 Set-up surface
9 Rail
10 Rail
11 Ceiling
12 Undercarriage
13 Driving arrangement
14 Mast
15 Guiding arrangement
16 Drive
17 LIFTING carriage
18 Telescopic arrangement
19 Fork arrangement
20 Load-receiving means
21 Final (end) extension
22 Telescopic arm
23 Telescopic arm
24 Load-supporting means
25 Load-carrying means
26 Caterpillar track arrangement
27 End area
28 End area
29 Axle
30 Reversing wheel
31 Revolving means
32 Shelf space
33 Shelf post
34 Supporting profile
35 Depth
36 Inside width
37 Width
38 Arrow
39 Surface
40 Pallet bottom
41 Underside
42 Surface
43 Arrow
44 Spacing
45 Arrow
46 Drive
47 Upper strand
48 Driving connection
49 Lower strand
50 Transmission
51 arrow
52 Length
53 Underside
54 Reinforcing profile
55 Z-profile
56 Leg
57 Roller arrangement
58 Length
59 Guiding arrangement
60 Adjusting device
61 Guiding arrangement
62 Double arrow
63 Height

1. A shelf-serving device for stocking and removing from storage pallets, storage boxes etc. in a shelf stockroom, comprising a lifting carriage displaceable in a shelf lane in the longitudinal and up directions, and having a telescoped load-receiving means adapted to drive into shelves (3) of the shelf stockroom, and an end extension (21) with at least one load-carrying means (25) adjustable between a position on the lifting carriage (17) and a position in the shelf (3), and a load-supporting means (24) supporting said end extension (21) as the latter is being driven into or out of the shelf (3), wherein the load-supporting means (24) is formed by at least one caterpillar track arrangement (26) with an endless revolving means (31), and another caterpillar track arrangement (26) or a roller arrangement (57) is arranged on the telescopic arm (24) as the load-carrying means (25).

2. The shelf-serving device according to claim 1, wherein the load-receiving means (20) is preferably formed by two telescopic arms (23), spaced from each other and each comprising a load-carrying means (25) and a load-supporting means (24).

3. (canceled)

4. The shelf-serving device according to claim 1, wherein the caterpillar track arrangements (26) of the load-supporting means (24) and the load-carrying means (25) are arranged aligned with each other in a plane extending perpendicular to a set-up surface (8) of the shelf-serving device (1), and the load-supporting means (24) are arranged on the telescopic arm (23) facing the set-up surface (8).

5. The shelf-serving device according to claim 1, wherein the caterpillar track arrangements (26) of the load-supporting means (24) and the load-carrying means (25) are arranged in planes offset parallel to one another and extending perpendicular to the set-up surface (8).

6. The shelf-serving device according to claim 1, wherein the caterpillar track arrangement (26) is formed by an endless chain, belt or cable strand on reversing wheels (30) arranged in end areas (27, 28) of the telescopic arm (23).

7. The shelf-serving device according to claim 1, wherein a length (58) of the caterpillar track arrangement (26) approximately conforms to a single shelf depth (35).

8. The shelf-serving device according to claim 1, wherein the telescopic arrangement (18) is formed by a two-arm telescopic device.

9. The shelf-serving device according to claim 1, wherein the caterpillar track arrangement (26) of the load-carrying means (25) is formed in two parts over the length of the latter.

10. The shelf-serving device according to claim 1, wherein the caterpillar track arrangement (26) particularly of the load-carrying means (25) is actively connected with a drive (46).

11. The shelf-serving device according to claim 1, wherein a drive motor of the caterpillar track arrangement (26) of the load-carrying device (25) is formed by an electric, fluid or hydro-motor.

12. The shelf-serving device according to claim 1, wherein the telescopic arrangement (18) is semi-rigidly supported on the lifting carriage (17) by and around an axle extending parallel to the set-up surface (8) and approximately perpendicularly to the direction of extension of the telescopic arrangement (26).

13. The shelf-serving device according to claim 1, wherein the caterpillar track arrangement (26) of the load-carrying device (25) is provided with a blocking device (51).

14. The shelf-serving device according to claim 1, wherein the roller axles of the roller arrangement (57) of the load-carrying means (25) extend perpendicularly to the direction of extension of the telescopic arrangement (18) and parallel to the set-up surface (8).

15. The shelf-serving device according claim 1, wherein an engageable retaining device is arranged for on the telescopic arm (23) for the pallets etc.

16. The shelf-serving device according to claim 1, wherein a driving connection (48) formed by a transmission (50) is provided between the caterpillar track arrangement (26) of the load-supporting means (24) and the caterpillar track arrangement (26) of the load-carrying means (25).

17. The shelf-serving device according to claim 1, wherein the driving connection (48) is disengageable.

18. The shelf-serving device according to claim 1, wherein the drives (46) are formed by speed-controlled, particularly rpm-controlled drives (46) controlled via a synchronizer and directly associated with the respective caterpillar arrangement (26).

19. The shelf-serving device according to claim 1, wherein the caterpillar track arrangements (26) of the load-carrying means (25) and the load-supporting means (24) are provided in end areas with inlet and outlet inclinations facing the pallet bottom (40) and the supporting profile (34).

20. The shelf-serving device according to claim 1, wherein a spacing (44) is adjustably formed between surfaces (39; 43) of the revolving means (31).

21. The shelf-serving device according claim 1, wherein an adjusting device (60) for a relative adjustment in the direction of an overall height (59) of the load-receiving means (20) is associated with at least one of the caterpillar track arrangements (26), particularly with the load-carrying means (25).

22. The shelf-serving device according to claim 1, wherein at least one of the caterpillar track arrangements (26), particularly the load-carrying means (25) is adjustably supported in a guiding arrangement (61) on the telescopic arm (23).

23. The shelf-serving device according claim 1, wherein the adjusting device (60) is formed by an eccentric drive, spindle drive, hydro-drive etc.

24. The shelf-serving device according to claim 1, wherein the range of adjustment of the adjusting device (60) is between 10 mm and 50 mm, particularly 30 mm.

25. The shelf-serving device according claim 1, wherein an adjusting force of the adjusting device (60) at least conforms to a gross load of the pallet (6).

26. The shelf-serving device according to claim 1, wherein a length (58) of the caterpillar track arrangements (26) approximately conforms to a depth (35) of the shelf (3).

27. The shelf-serving device according to claim 1, wherein a revolving means (31) of the caterpillar track arrangements (26) is formed by chains, belts, straps etc.

28. The shelf-serving device according to claim 27, wherein a guiding arrangement (59) is associated with the revolving means (31) between reversing wheels (30).
